(19) United States
(12) Patent Application Publication
(10) Pub. No.: US 2026/0342991 A1
(43) Pub. Date: Oct. 29, 2026

(54) Method and Apparatus of Subblock-based Motion Vector Prediction with Reordering and Refinement in Video Coding

(71) Applicant: MEDIATEK INC., Hsinchu City (TW)

(72) Inventors: Chen-Yen LAI, Hsinchu City (TW); Ching-Yeh CHEN, Hsinchu City (TW); Tzu-Der CHUANG, Hsinchu City (TW); Chih-Wei HSU, Hsinchu City (TW); Yi-Wen CHEN, San Jose, CA (US)

(21) Appl. No.: 19/120,419

(22) PCT Filed: Sep. 26, 2023
(86) PCT No.: PCT/CN2023/121759

§ 371 Date: Apr. 11, 2025

Related U.S. Application Data
(60) Provisional application No. 63/379,459, filed on Oct. 14, 2022.

(51) Int. Cl. H04N 19/137; H04N 19/105; H04N 19/176; H04N 19/70

(52) U.S. Cl. CPC H04N 19/137; H04N 19/105; H04N 19/176; H04N 19/70

(57) ABSTRACT

Methods and apparatus for video coding using SbTMVP (Subblock-based Temporal Motion Vector Prediction). According to the method, one or more motion shift candidates are determined based on one or more spatial neighbouring blocks of the current block. Multiple collocated reference blocks in a collocated picture are determined based on said one or more motion shift candidates and said one or more spatial neighbouring blocks of the current block respectively. A target collocated reference block is determined from the multiple collocated reference blocks. Subblock motion information for subblocks of the current block is derived based on target motion information of corresponding subblocks of the target collocated reference block. An SbTMVP candidate for the current block is generated based on the subblock motion information for the subblocks of the current block. The current block is encoded or decoded by using a motion prediction set comprising the SbTMVP candidate.

### CROSS REFERENCE TO RELATED APPLICATIONS

The present invention is a non-Provisional Application of and claims priority to U.S. Provisional Patent Application No. 63/379,459, filed on Oct. 14, 2022. The U.S. Provisional Patent Application is hereby incorporated by reference in its entirety.

### FIELD OF THE INVENTION

The present invention relates to video coding system using SbTMVP (Subblock-based Temporal Motion Vector Prediction). In particular, the present invention relates to techniques to improve the coding efficiency for SbTMVP.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video coding system incorporating loop processing. For Intra Prediction, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

The VVC standard incorporates various new coding tools to further improve the coding efficiency over the HEVC standard. Among various new coding tools, some coding tools relevant to the present invention are reviewed as follows.

### Subblock-Based Temporal Motion Vector Prediction (SbTMVP) in VVC

VVC supports the subblock-based temporal motion vector prediction (SbTMVP) method. Similar to the temporal motion vector prediction (TMVP) in HEVC, SbTMVP uses the motion field in the collocated picture to improve motion vector prediction and merge mode for CUs in the current picture. The same collocated picture used by TMVP is used for SbTMVP. SbTMVP differs from TMVP in the following two main aspects:
TMVP predicts motion at CU level but SbTMVP predicts motion at sub-CU level;
Whereas TMVP fetches the temporal motion vectors from the collocated block in the collocated picture (i.e., the collocated block is the bottom-right or centre block relative to the current CU), SbTMVP applies a motion shift before fetching the temporal motion information from the collocated picture, where the motion shift is obtained from the motion vector from one of the spatial neighbouring blocks of the current CU.

The SbTMVP process is illustrated in FIGS. 2A-B. SbTMVP predicts the motion vectors of the sub-CUs within the current CU in two steps. In the first step, the spatial neighbour A1 of the current block 222 in the current picture 220 in FIG. 2A is examined. If A1 has a motion vector that uses the collocated picture as its reference picture, this motion vector is selected to be the motion shift to be applied. If no such motion is identified, then the motion shift is set to (0, 0).

In the second step, the motion shift 240 identified in Step 1 is applied (i.e. added to the current block's coordinates) to obtain sub-CU level motion information (motion vectors and reference indices) from the collocated picture 230 as shown in FIG. 2B. The example in FIG. 2B assumes the motion shift is set to block A1's motion, and the collocated block 232 in the collocated picture 230 can be located based on the collocated reference subblock A1′. Then, for each sub-CU of the current CU 222, the motion information of its corresponding block (the smallest motion grid that covers the centre sample) in the collocated picture is used to derive the motion information for the sub-CU of the collocated CU 232. For example, the motion information of the upper-left subblock of the collocated CU 232 is used to derive prediction for the motion information of the upper-left subblock of the current CU 222. After the motion information of the collocated sub-CU is identified, it is converted to the motion vectors and reference indices of the current sub-CU in a similar way as the TMVP process of HEVC, where temporal motion scaling is applied to align the reference pictures of the temporal motion vectors to those of the current CU. In FIG. 2B, the arrow(s) in each subblock of the collocated picture 230 correspond(s) to the motion vector(s) of a collocated subblock (thick-lined arrow for L0 MV and thin-lined arrow for L1 MV). For the current picture 220, the arrow(s) in each subblock correspond(s) to the scaled motion vector(s) of a current subblock (thick-lined arrow for L0 MV and thin-lined arrow for L1 MV). If no motion information of the collocated sub-CU is available (e.g. an intra coded subblock), a default motion is used.

In VVC, a combined subblock based merge list, which contains both SbTMVP candidate and affine merge candidates, is used for the signalling of subblock based merge mode. The SbTMVP mode is enabled/disabled by a sequence parameter set (SPS) flag. If the SbTMVP mode is enabled, the SbTMVP predictor is added as the first entry of the list of subblock based merge candidates, and followed by the affine merge candidates. The size of subblock based merge list is signalled in SPS and the maximum allowed size of the subblock based merge list is 5 in VVC.

The sub-CU size used in SbTMVP is fixed to be 8×8, and as done for the affine merge mode, SbTMVP mode is only applicable to the CU with both width and height are larger than or equal to 8.

The encoding processing flow of the additional SbTMVP merge candidate is the same as for the other merge candidates, that is, for each CU in P or B slice, an additional RD check is performed to decide whether to use the SbTMVP candidate.

### Non-Adjacent Spatial Candidate

During the development of the VVC standard, a coding tool referred as Non-Adjacent Motion Vector Prediction (NAMVP) has been proposed in JVET-L0399 (Yu Han, et al., “CE4.4.6: Improvement on Merge/Skip mode”, Joint Video Exploration Team (JVET) of ITU-T SG 16 WP 3 and ISO/IEC JTC 1/SC 29/WG 11, 12th Meeting: Macao, CN, 3-12 Oct. 2018, Document: JVET-L0399). According to the NAMVP technique, the non-adjacent spatial merge candidates are inserted after the TMVP (i.e., the temporal MVP) in the regular merge candidate list. The pattern of spatial merge candidates is shown in FIG. 3. The distances between non-adjacent spatial candidates and current coding block are based on the width and height of current coding block. In FIG. 3, each small numbered box corresponds to a NAMVP candidate and the candidates are ordered (as shown by the number inside the square) according to the distance.

### Multi-Pass Decoder-Side Motion Vector Refinement (MP-DMVR)

A multi-pass decoder-side motion vector refinement is applied. In the first pass, bilateral matching (BM) is applied to the coding block. In the second pass, BM is applied to each 16×16 subblock within the coding block. In the third pass, MV in each 8×8 subblock is refined by applying bi-directional optical flow (BDOF). The refined MVs are stored for both spatial and temporal motion vector prediction.

### First Pass—Block Based Bilateral Matching MV Refinement

In the first pass, a refined MV is derived by applying BM to a coding block. Similar to decoder-side motion vector refinement (DMVR), in the bi-prediction operation, a refined MV is searched around the two initial MVs (i.e., MV0 and MV1) in the reference picture lists L0 and L1. The refined MVs (i.e., MV0_pass1 and MV1_pass1) are derived around the initiate MVs based on the minimum bilateral matching cost between the two reference blocks in L0 and L1.

BM performs local search to derive integer sample precision intDeltaMV. The local search applies a 3×3 square search pattern to loop through the search range [−sHor, sHor] in the horizontal direction and [−sVer, sVer] in the vertical direction, wherein, the values of sHor and sVer are determined by the block dimension, and the maximum value of sHor and sVer is 8.

The bilateral matching cost is calculated as: bilCost=mvDistanceCost+sadCost. When the block size cbW*cbH is greater than 64, MRSAD cost function is applied to remove the DC effect of distortion between reference blocks. When the bilCost at the centre point of the 3×3 search pattern has the minimum cost, the intDeltaMV local search is terminated. Otherwise, the current minimum cost search point becomes the new centre point of the 3×3 search pattern and continue to search for the minimum cost, until it reaches the end of the search range.

The existing fractional sample refinement is further applied to derive the final deltaMV. The refined MVs after the first pass are then derived as:

$$MV0\_pass1 = MV 0 + deltaMV$$

$$MV1\_pass1 = MV 1 - deltaMV$$

### Second Pass—Subblock Based Bilateral Matching MV Refinement

In the second pass, a refined MV is derived by applying BM to a 16×16 grid subblock. For each subblock, a refined MV is searched around the two MVs (e.g. MV0_pass1 and MV1_pass1), obtained during the first pass, in the reference picture list L0 and L1. The refined MVs (i.e., MV0_pass2(sbIdx2) and MV1_pass2(sbIdx2)) are derived based on the minimum bilateral matching cost between the two reference subblocks in L0 and L1.

For each subblock, BM performs full search to derive integer sample precision intDeltaMV. The full search has a search range [−sHor, sHor] in the horizontal direction and [−sVer, sVer] in the vertical direction, wherein, the values of sHor and sVer are determined by the block dimension, and the maximum value of sHor and sVer is 8.

The bilateral matching cost is calculated by applying a cost factor to the SATD cost between two reference subblocks, as: bilCost=satdCost*costFactor. The search area (2*sHor+1)*(2*sVer+1) is divided up to 5 diamond shape search regions shown on FIG. 4, where the 5 search regions are shown in 5 different shades. Each search region is assigned a costFactor, which is determined by the distance (intDeltaMV) between each search point and the starting MV, and each diamond region is processed in the order starting from the centre of the search area. In each region, the search points are processed in the raster scan order starting from the top left going to the bottom right corner of the region. When the minimum bilCost within the current search region is less than a threshold equal to sbW*sbH, the int-pel full search is terminated; otherwise, the int-pel full search continues to the next search region until all search points are examined. Additionally, if the difference between the previous minimum cost and the current minimum cost in the iteration is less than a threshold that is equal to the area of the block, the search process terminates.

The existing VVC DMVR fractional sample refinement is further applied to derive the final deltaMV(sbIdx2). The refined MVs at second pass is then derived as:

$$MV0\_pass2 ( sbIdx 2 ) = MV0\_pass1 + deltaMV ( sbIdx 2 )$$

$$MV1\_pass2 ( sbIdx 2 ) = MV1\_pass1 - deltaMV ( sbIdx 2 )$$

### Third Pass—Subblock Based Bi-Directional Optical Flow MV Refinement

In the third pass, a refined MV is derived by applying BDOF to an 8×8 grid subblock. For each 8×8 subblock, BDOF refinement is applied to derive scaled Vx and Vy without clipping starting from the refined MV of the parent subblock of the second pass. The derived bioMv(Vx, Vy) is rounded to 1/16 sample precision and clipped between −32 and 32.

The refined MVs (e.g. MV0_pass3(sbIdx3) and MV1_pass3(sbIdx3)) at third pass are derived as:

$$MV0\_pass3 ( sbIdx 3 ) = MV0\_pass2 ( sbIdx 2 ) + bioMv$$

$$MV1\_pass3 ( sbIdx 3 ) = MV0\_pass2 ( sbIdx 2 ) - bioMv$$

### Adaptive Decoder-Side Motion Vector Refinement

Adaptive decoder side motion vector refinement method is an extension of multi-pass DMVR which consists of the two new merge modes to refine MV only in one direction, either L0 or L1, of the bi prediction for the merge candidates that meet the DMVR conditions. The multi-pass DMVR process is applied for the selected merge candidate to refine the motion vectors, however either MVD0 or MVD1 is set to zero in the 1^{st} pass (i.e. PU level) DMVR.

The merge candidates for the new merge mode are derived from spatial neighbouring coded blocks, TMVPs, non-adjacent blocks, HMVPs, pair-wise candidate, similar as in the regular merge mode. The difference is that only those meet DMVR conditions are added into the candidate list. The same merge candidate list is used by the two new merge modes. If the list of BM candidates contains the inherited BCW weights and DMVR process is unchanged except the computation of the distortion is made using MRSAD or MRSATD if the weights are non-equal and the bi-prediction is weighted with BCW weights. Merge index is coded as in regular merge mode.

### Template Matching for MV Refinement

Template matching (TM) is a decoder-side MV derivation method to refine the motion information of the current CU by finding the closest match between a template (i.e., top 514 and/or left 516 neighbouring blocks of the current CU 512) in the current picture 510 and a block (i.e., same size to the template, block 524 and 526) in a reference picture 520 as shown in FIG. 5. In FIG. 5, a better MV is searched around the initial motion 530 of the current CU 512 of the current picture 510 within a [−8, +8]-pel search range 522 around location 528 in the reference picture 520 as pointed by the initial MV 530. The template matching method in JVET-J0021 (Yi-Wen Chen, et al., “Description of SDR, HDR and 360° video coding technology proposal by Qualcomm and Technicolor—low and high complexity versions”, Joint Collaborative Team on Video Coding (JCT-VC) of ITU-T SG16 WP3 and ISO/IEC JTC 1/SC 29/WG11, 10th Meeting: San Diego, US, 10-20 Apr. 2018, Document: JVET-J0021) is used with the following modifications: search step size is determined based on AMVR mode and TM can be cascaded with bilateral matching process in merge modes.

In the AMVP mode, an MVP candidate is determined based on the template matching error to select the one which reaches the minimum difference between the current block template and the reference block template. TM is then performed only for this particular MVP candidate for MV refinement. TM refines this MVP candidate by using iterative diamond search starting from full-pel MVD precision (or 4-pel for 4-pel AMVR mode) within a [−8, +8]-pel search range. The AMVP candidate may be further refined by using cross search with full-pel MVD precision (or 4-pel for 4-pel AMVR mode), followed sequentially by half-pel and quarter-pel ones depending on AMVR mode as specified in Table 1. This search process ensures that the MVP candidate still keeps the same MV precision as indicated by the AMVR mode after the TM process. In the search process, if the difference between the previous minimum cost and the current minimum cost in the iteration is less than a threshold that is equal to the area of the block, the search process terminates.

TABLE 1
Search patterns of AMVR and merge mode with AMVR.

| | AMVR mode | | | | Merge mode | |
|---|---|---|---|---|---|---|
| | 4- | Full- | Half- | Quarter- | AltIF = | AltIF = |
| Search pattern | pel | pel | pel | pel | 0 | 1 |
| 4-pel diamond | v | | | | | |
| 4-pel cross | v | | | | | |
| Full-pel diamond | | v | v | v | v | v |
| Full-pel cross | | v | v | v | v | v |
| Half-pel cross | | | v | v | v | v |
| Quarter-pel cross | | | | v | v | |
| 1/8-pel cross | | | | | v | |

In the merge mode, similar search method is applied to the merge candidate indicated by the merge index. As shown in Table 1, TM may be performed all the way down to ⅛-pel MVD precision or skipping those beyond half-pel MVD precision, depending on whether the alternative interpolation filter (used for AMVR being a half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

Adaptive Reordering of Merge Candidates with Template Matching (ARMC-TM)

The merge candidates are adaptively reordered according to costs evaluated using template matching (TM). The reordering method can be applied to the regular merge mode, template matching (TM) merge mode, and affine merge mode (excluding the SbTMVP candidate). For the TM merge mode, merge candidates are reordered before the refinement process.

After a merge candidate list is constructed, merge candidates are divided into multiple subgroups. The subgroup size is set to 5 for the regular merge mode and TM merge mode. The subgroup size is set to 3 for the affine merge mode. Merge candidates in each subgroup are reordered ascendingly according to cost values based on template matching. For ARMC-TM, the candidates in a subgroup are skipped if the subgroup satisfies the following 2 conditions: (1) the subgroup is the last subgroup and (2) the subgroup is not the first subgroup. For simplification, merge candidates in the last, but not the first subgroup, are not reordered.

The template matching cost of a merge candidate is measured as the sum of absolute differences (SAD) between samples of a template of the current block and their corresponding reference samples. The template comprises a set of reconstructed samples neighbouring to the current block. Reference samples of the template are located by the motion information of the merge candidate.

When a merge candidate utilizes bi-directional prediction, the reference samples of the template of the merge candidate are also generated by bi-prediction as shown in FIG. 6. In FIG. 6, block 612 corresponds to a current block in current picture 610, blocks 622 and 632 correspond to reference blocks in reference pictures 620 and 630 in list 0 and list 1 respectively. Templates 614 and 616 are for current block 612, templates 624 and 626 are for reference block 622, and templates 634 and 636 are for reference block 632. Motion vectors 640, 642 and 644 are merge candidates in list 0 and motion vectors 650, 652 and 654 are merge candidates in list 1.

For subblock-based merge candidates with subblock size equal to Wsub×Hsub, the above template comprises several sub-templates with the size of Wsub×1, and the left template comprises several sub-templates with the size of 1×Hsub. As shown in FIG. 7, the motion information of the subblocks in the first row and the first column of current block is used to derive the reference samples of each sub-template. In FIG. 7, block 712 corresponds to a current block in current picture 710 and block 722 corresponds to a collocated block in reference picture 720. Each small square in the current block and the collocated block corresponds to a subblock. The dot-filled areas on the left and top of the current block correspond to template for the current block. The boundary subblocks are labelled from A to G. The arrow associated with each subblock corresponds to the motion vector of the subblock. The reference subblocks (labelled as Aref to Gref) are located according to the motion vectors associated with the boundary subblocks.

Merge Mode with MVD (MMVD)

In addition to merge mode, where the implicitly derived motion information is directly used for prediction samples generation of the current CU, the merge mode with motion vector differences (MMVD) is introduced in VVC. An MMVD flag is signalled right after sending a regular merge flag to specify whether MMVD mode is used for a CU.

In MMVD, after a merge candidate is selected, it is further refined by the signalled MVDs information. The further information includes a merge candidate flag, an index to specify motion magnitude, and an index for indication of motion direction. In MMVD mode, one of the first two candidates in the merge list is selected to be used as MV basis. The MMVD candidate flag is signalled to specify which one is used between the first and second merge candidates.

Distance index specifies motion magnitude information and indicates the pre-defined offset from the starting points (812 and 822) for a L0 reference block 810 and L1 reference block 820 as shown in FIG. 8. In FIG. 8, an offset is added to either the horizontal component or the vertical component of the starting MV, where small circles in different styles correspond to different offsets from the centre. The relation between the distance index and pre-defined offset is specified in Table 2.

TABLE 2
The relation of distance index and pre-defined offset

| Distance | | | | | | | | |
|---|---|---|---|---|---|---|---|---|
| IDX | 0 | 1 | 2 | 3 | 4 | 5 | 6 | 7 |
| Pixel | 1/4-pel | 1/2-pel | 1-pel | 2-pel | 4-pel | 8-pel | 16-pel | 32-pel |
| distance | | | | | | | | |

Direction index represents the direction of the MVD relative to the starting point. The direction index can represent of the four directions as shown below. Direction index represents the direction of the MVD relative to the starting point. The direction index can represent the four directions as shown in Table 3. It is noted that the meaning of MVD sign could be variant according to the information of starting MVs. When the starting MVs are an un-prediction MV or bi-prediction MVs with both lists pointing to the same side of the current picture (i.e. POCs of two references both larger than the POC of the current picture, or both smaller than the POC of the current picture), the sign in Table 3 specifies the sign of the MV offset added to the starting MV. When the starting MVs are bi-prediction MVs with the two MVs pointing to the different sides of the current picture (i.e. the POC of one reference larger than the POC of the current picture, and the POC of the other reference smaller than the POC of the current picture), and the difference of POC in list 0 is greater than the one in list 1, the sign in Table 3 specifies the sign of MV offset added to the list0 MV component of the starting MV and the sign for the list1 MV has an opposite value. Otherwise, if the difference of POC in list 1 is greater than list 0, the sign in Table 3 specifies the sign of the MV offset added to the list1 MV component of starting MV and the sign for the list 0 MV has an opposite value.

The MVD is scaled according to the difference of POCs in each direction. If the differences of POCs in both lists are the same, no scaling is needed. Otherwise, if the difference of POC between list 0 (i.e., L0) reference picture and the current picture is larger than the one between list 1 (i.e., L1) picture and the current picture, the MVD for list 1 is scaled according to a ratio of td and tb, where td corresponds to the POC difference of L0 reference picture and the current picture and tb corresponds to POC difference of L1 reference picture and the current picture. If the difference of POC between L1 reference picture and the current picture is greater than the one between L0 reference picture and the current picture, the MVD for list 0 is scaled in the similar way. If the starting MV is uni-predicted, the MVD is added to the available MV.

TABLE 3
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

In the present invention, schemes to further improve the performance for SbTMVP are disclosed.

### BRIEF SUMMARY OF THE INVENTION

A method and apparatus for video coding using SbTMVP (Subblock-based Temporal Motion Vector Prediction) are disclosed. According to the method, input data associated with a current block are received, wherein the input data comprise pixel data for the current block to be encoded at an encoder side or encoded data associated with the current block to be decoded at a decoder side. One or more motion shift candidates are determined based on one or more spatial neighbouring blocks of the current block. Two or more collocated reference blocks in a collocated picture are determined based on said one or more motion shift candidates and said one or more spatial neighbouring blocks of the current block respectively. A target collocated reference block is determined from said two or more collocated reference blocks. Subblock motion information for subblocks of the current block is derived based on target motion information of corresponding subblocks of the target collocated reference block. An SbTMVP (Subblock-based Temporal Motion Vector Prediction) candidate for the current block is generated based on the subblock motion information for the subblocks of the current block. The current block is encoded or decoded by using a motion prediction set comprising the SbTMVP candidate.

In one embodiment, said two or more collocated reference blocks in the collocated picture are determined by locating a base collocated reference block according to a location of a target spatial neighbouring block of the current block and a target motion shift candidate associated with the target spatial neighbouring block of the current block, and one or more additional collocated reference blocks are located by adding one or more additional motion shifts to the base collocated reference block. In one embodiment, the target spatial neighbouring block of the current block corresponds to a bottom-left neighbouring block and three additional collocated reference blocks are located on top side, left side and bottom side of the base collocated reference block respectively. In one embodiment, the target collocated reference block is determined from said two or more collocated reference blocks according to Rate-Distortion costs associated with said two or more collocated reference blocks.

In one embodiment, a first syntax is signalled or parsed to indicate whether said two or more collocated reference blocks are used. In one embodiment, when the first syntax indicates said two or more collocated reference blocks being used, a second syntax is signalled or parsed to indicate the target collocated reference block as selected.

In one embodiment, when two or more motion shift candidates based on two or more spatial neighbouring blocks of the current block are determined, said two or more collocated reference blocks in the collocated picture comprise one base collocated reference block from each of said two or more motion shift candidates and said one base collocated reference block is located according to a location of each spatial neighbouring block of the current block and a target motion shift candidate associated with said one base collocated reference block. In one embodiment, a first syntax is signalled or parsed to indicate whether said two or more motion shift candidates are used. In one embodiment, when the first syntax indicates said two or more motion shift candidates being used, a second syntax is signalled or parsed to indicate which base collocated reference block is selected. In another embodiment, the first syntax is signalled or parsed only if affine MMVD is disabled for the current block.

In one embodiment, corresponding SbTMVP candidates associated with said two or more collocated reference blocks are reordered according to ARMC-TM (Adaptive Reordering of Merge Candidates with Template Matching). In one embodiment, after the corresponding SbTMVP candidates are reordered, N best candidates are used for further rate-distortion cost evaluation, and wherein N is smaller than or equal to a total number of the corresponding SbTMVP candidates. In one embodiment, a set of indexes is used to indicate the N best candidates and a smaller index value is signalled using a shortened codeword. In one embodiment, one or more templates of the current block and one or more corresponding templates of the target collocated reference block are used for the ARMC-TM. In another embodiment, one or more templates of the current block and one or more corresponding templates of the target collocated reference block are used for the ARMC-TM, and wherein the subblocks of the target collocated reference block are located based on subblock motions.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2A illustrates an example of subblock-based Temporal Motion Vector Prediction (SbTMVP) in VVC, where the spatial neighbouring blocks are checked for availability of motion information.

FIG. 2B illustrates an example of SbTMVP for deriving sub-CU motion field by applying a motion shift from spatial neighbour and scaling the motion information from the corresponding collocated sub-CUs.

FIG. 3 illustrates an exemplary pattern of the non-adjacent spatial merge candidates.

FIG. 4 illustrates the 5 diamond shape search regions used for multi-pass decoder-side motion vector refinement.

FIG. 5 illustrates an example of template matching used to refine an initial MV by searching an area around the initial MV.

FIG. 6 illustrates an example of templates used for the current block and corresponding reference blocks to measure matching costs associated with merge candidates.

FIG. 7 illustrates the offset distances in the horizontal and vertical directions for a L0 reference block and L1 reference block according to MMVD.

FIG. 8 illustrates an example of Merge mode with MVD (MMVD), where distance index specifies motion magnitude information and indicates the pre-defined offset from the starting points for a L0 reference block and L1 reference block.

FIG. 9A illustrates an example of SbTMVP with multiple motion vector shifts (sbTMVP with Mmvs) according to an embodiment of the present invention, where a motion shift based on A1 is used to located A1′ in the collocated picture and additional candidates (T1, L1 and B1) are located by adding additional shifts.

FIG. 9B illustrates an example of the collocated reference block associated with candidate L1.

FIG. 10 illustrates an example of deriving multiple collocated reference blocks based on two different motion shifts associated with A1 and TR1 neighbouring blocks.

FIG. 11 illustrates an example of CU based template for calculating the template matching cost.

FIG. 12 illustrates a flowchart of an exemplary video coding system that utilizes SbTMVP with multiple motion shifts according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

To improve coding efficiency of SbTMVP for Skip, Merge, Direct, Intra modes, Inter modes, and/or IBC modes, methods related to SbTMVP with multiple motion shifts are disclosed.

In one embodiment, a motion vector of non-adjacent spatial neighbouring blocks is used as a motion shift.

In one embodiment, the motion shift derivation is related to TM and/or ARMC-TM with the following variations:
A motion shift is refined by TM with CU template.
Two or more motion vectors of adjacent and/or non-adjacent spatial neighbouring blocks are reordered by ARMC-TM, then the first one or more are selected as the motion shift.
Two or more motion vectors of adjacent and/or non-adjacent spatial neighbouring blocks are refined by TM, then reordered by ARMC-TM, then the first one or more motion vectors are selected as the motion shift.
Two or more motion vectors of adjacent and/or non-adjacent spatial neighbouring blocks are reordered by ARMC-TM, then the first one or more motion vectors are selected as the motion shift and then refined by TM.
In the process of TM or ARMC-TM, set the cost of motion vector of TM or ARMC-TM to a large value or skip a motion vector if treating a motion vector as a motion shift would make a SbTMVP candidate not available (i.e., the default motion is not available).

In one embodiment, the default motion is further refined by TM and/or BM with the following variations:
A default motion is refined by TM with the CU template.
A default motion is refined by BM.
A default motion is refined by TM and then BM.
A default motion is refined by BM and then TM.

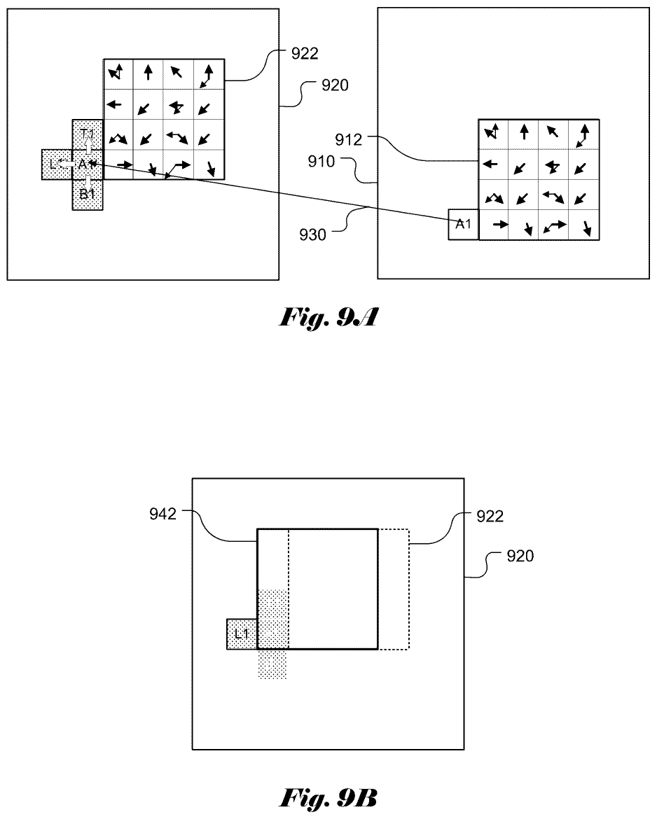

To further improve coding efficiency, in one embodiment, SbTMVP with multiple motion vector shifts (sbTMVP with Mmvs) is proposed as a new mode. In other words, more than one sbTMVP with different motion shift candidates are tried and the best one will be selected based on the RD cost. For example, as shown in FIG. 9A with a current CU 912 in current picture 910 and the collocated picture 920, A1 is a bottom-left neighbouring subblock block of the current block 912. The motion vector 930 points to A1′ in the collocated picture 920 and the collocated CU 922 can be located according to A1. In one embodiment, the first sbTMVP with Mmvs candidate derived based on the temporal motion from A1 is candidate 0 (i.e., A1′). The second sbTMVP with Mmvs candidate derived based on the temporal motion from A1 and with motion shift to left 4 pixels is candidate 1 (i.e., L1). In other words, subblock L1 is located by shifting A1′ to the left by 4 pixels. The corresponding collocated CU 942 can be located according to L1 as shown in FIG. 9B. The third sbTMVP with Mmvs candidate derived based on the temporal motion from A1 and with the motion shift to top 4 pixels is candidate 2 (i.e., T1). The fourth sbTMVP with Mmvs candidate derived based on the temporal motion from A1 and with the motion shift to bottom 4 pixels is candidate 3 (i.e., B1). In other words, the four sbTMVPs are generated by adding addition motion shifts to a base motion shift 930 so that three additional collocated reference blocks (i.e., T1, L1 and B1 in FIG. 9A) are identified in addition to a base collocated reference block (i.e., A1′). The collocated CUs corresponding to B1 and T1 can be determined in a way similar to that for L1. After that, the best sbTMVP with Mmvs candidate is determined based on Rate-Distortion (RD) cost. A flag (i.e., sbtmvp_mmvd_flag) is signalled to indicate the on-off of sbTMVP with Mmvs. If sbtmvp_mmvd_flag is equal to 1, sbtmvp_merge_idx is signalled to indicate the best candidate in sbTMVP with Mmvs candidate list.

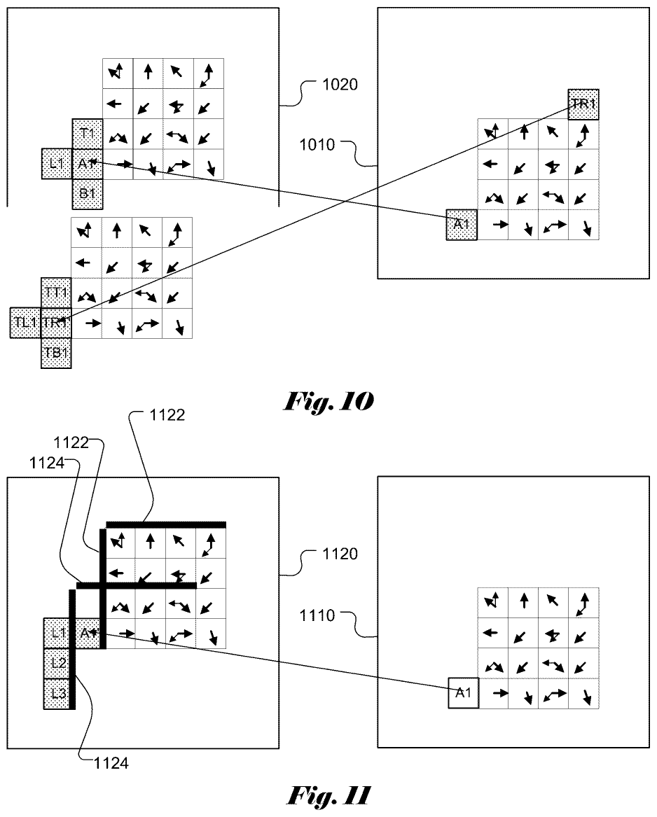

In another embodiment, stmvp_base_idx can be further signalled if sbtmvp_mmvd_flag is equal to 1 to indicate different initial candidate (base candidate). As shown in FIG. 10 with current picture 1010 and the collocated picture 1020, more than one base candidate is applied, sbtmvp_base_idx is signalled to indicate the best candidate derived from base candidate 0 (i.e., A1) or base candidate 1 (i.e., TR1). If the best candidate is derived from base 1 (i.e., TR1), then the sbtmvp_merge_idx is used to indicate the best candidate being TT1, TB1, or TL1. If the best candidate is derived from base 0 (i.e., A1), then the sbtmvp_merge_idx is used to indicate the best candidate being T1, B1, or L1.

In another embodiment, stmvp_base_idx can be further signalled if sbtmvp_mmvd_flag is equal to 1 to indicate different initial candidate (i.e., base candidate). For example, base candidate 0 is the motion at A1 position from collocated picture 0 and base candidate 1 is the motion at A1 position from collocated picture 1.

In another embodiment, stmvp_base_idx can be further signalled if sbtmvp_mmvd_flag is equal to 1 to indicate different initial candidate (i.e., base candidate). For example, base candidate 0 is the motion at A1 position from collocated picture 0 and base candidate 1 is the motion at A1 position from collocated picture 1. If both L0 and L1 motions of A1 position are not from collocated picture 0 or collocated picture 1, motion scaling technique can be used on the motion from L0 or motion from L1.

In another embodiment, sbTMVP with multiple subblock motion shift (sbTMVP with sMmvs) is proposed as a new mode. That means more than one motion shifts are added on each subblock motion of a sbTMVP candidate to generate more than one sbTMVP with sMmvs candidates. For example, an sbTMVP candidate is generated by using a motion from A1. After that, a group of subblock motions (i.e., initial motion group) are derived and more than one subblock motion shift will be added to each subblock motion of the initial motion group to generate more sbTMVP with sMmvs candidates. The best sbTMVP with an sMmvs candidate will be selected based on the RD cost of each candidate. A flag (i.e. sbtmvp_mmvd_flag) is signalled to indicate the on-off of sbTMVP with sMmvs. If sbtmvp_mmvd_flag is equal to 1, sbtmvp_merge_idx is signalled to indicate the best candidate in sbTMVP with sMmvs candidate list.

To make related syntax signalling more efficient, ARMC-TM is performed on the candidate list of sbTMVP with sMmvs or sbTMVP with Mmvs.

In another embodiment, the candidate list of sbTMVP with sMmvs or sbTMVP with Mmvs can be reordered according to ARMC-TM first, and only the best N candidates after reordering will be used to calculate the RD cost for comparison. N is an integer smaller than or equal to the number of candidates in candidate list. By doing this, the more promising candidate will be assigned with a smaller index, and the smaller index can be signalled by a shorter codeword.

Regarding the TM cost calculation, there are two proposed methods as follows:
The TM cost is calculated by the template of current block on the collocated picture. FIG. 11 shows templates of candidate A1′ and L3. TM costs are calculated based on CU templates (1122 for A1′ and 1124 for L3), where current picture 1110 and collocated picture 1120 are shown.
The TM cost is calculated by using subblock motions similar to the technique shown in FIG. 7.

In another embodiment, the availability of sbTMVP with sMmvs or sbTMVP with Mmvs candidates are checked before RD calculation. The invalid candidates (if the centre position of current block of a candidate on the collocated picture is intra mode or IBC mode, the candidate is treated as invalid) are removed and the final candidate list is generated which does not include invalid candidates. By doing so, the index of more promising candidates can use a shortened codeword to signal.

### Related Syntax Design:

To improve the coding efficiency of sbTMVP with sMmvs and sbTMVP with Mmvs mode, several syntax designs are proposed. The following methods use sbTMVP with Mmvs mode as an example, and they all can be applied on sbTMVP with sMmvs mode.

In one embodiment, a flag (e.g. sbtmvp_mmvd_flag) is signalled to indicate the on-off of sbTMVP with Mmvs. If sbtmvp_mmvd_flag is equal to 1, sbtmvp_merge_idx is signalled to indicate the best candidate in sbTMVP with Mmvs candidate list. sbtmvp_base_idx is signalled if more than one base candidate is used and they are signalled after affine with mmvd related syntax. An exemplary syntax design is shown as following.

```
Syntax design 1:
If (subblock_merge_mode)
{
  affine_mmvd_flag
  if (affine_mmvd_flag) {
    affine_base_idx
    affine_merge_idx
    }
    if (affine_mmvd_flag == false) {
      sbtmvp_mmvd_flag
      if (sbtmvp_mmvd_flag) {
        sbtmvp_base_idx
      sbtmvp_merge_idx
      }
    }
}
```

In another embodiment, SbTMVP with Mmvs can only be enabled when sbTMVP is present in affine merge candidate list. Therefore, affine with mmvd only can be enabled when sbTMVP is not present in the affine merge candidate list. That means SbTMVP with Mmvs can share the same syntax data with affine with mmvd. By checking the affine merge candidate list, the decoder can know either SbTMVP with Mmvs or affine with mmvd is enabled. If sbTMVP is present in affine merge candidate list, and subblock_mmvd_flag is equal to 1, SbTMVP with Mmvs is enabled. An exemplary syntax design is shown as following.

```
Syntax design 2:
If (subblock_merge_mode)
{
  subblok_mmvd_flag
  if (subblok_mmvd_flag) {
    subblok_base_idx
    subblok_merge_idx
    }
}
```

In syntax deign 1, if all sbTMVP with Mmvs candidates are invalid (i.e. collocated picture is all intra picture), sbtmvp_mmvd_flag needs to be signalled and it must be 0. To make the syntax signalling more efficient, in another embodiment, in the case of all sbTMVP with Mmvs candidates are invalid, affine with mmvd can apply 2 bases candidate without signalling affine_base_idx. The syntax design is shown as following. In the encoder, the number of base candidate of affine with mmvd is equal to 1 when at least one of sbTMVP with Mmvs candidate is valid. And the number of base candidate of affine with mmvd is equal to 2 when none of sbTMVP with Mmvs candidate is valid. An exemplary semantic of affine_mmvd_flag, affine_merge_idx, sbtmvp_mmvd_flag, and sbtmvp_merge_idx are defined as followings.

```
Syntax design 3:
If (subblock_merge_mode)
{
  affine_mmvd_flag
  if (affine_mmvd_flag) {
    affine_merge_idx
    }
    if (affine_mmvd_flag == false) {
      sbtmvp_mmvd_flag
      if (sbtmvp_mmvd_flag) {
        sbtmvp_merge_idx
      }
    }
}
```

affine_mmvd_flag[x0][y0] equal to 1 specifies that for the current coding unit, affine with mmvd is enabled. The array indices x0, y0 specify the location (x0, y0) of the top-left luma sample of the considered coding block relative to the top-left luma sample of the picture.

affine_merge_idx[x0][y0] specifies the merging candidate index of the affine with mmvd candidate list where x0, y0 specify the location (x0, y0) of the top-left luma sample of the considered coding block relative to the top-left luma sample of the picture.

sbtmvp_mmvd_flag[x0][y0] equal to 1 specifies that for the current coding unit, sbtmvp with Mmvs is enabled or base candidate 1 is used in affine with mmvd_. The array indices x0, y0 specify the location (x0, y0) of the top-left luma sample of the considered coding block relative to the top-left luma sample of the picture. If none of sbTMVP with Mmvs candidates is valid, affineBaseIdx is equal to sbtmvp_mmvd_flag; otherwise, affineBaseIdx is equal to 0. And if none of sbTMVP with Mmvs candidates is valid and sbtmvp_mmvd_flag is equal to 1, affineEnableFlag is equal to 1; otherwise, affineEnableFlag is equal to affine_mmvd_flag.

sbtmvp_merge_idx[x0][y0] specifies the merging candidate index of the SbTMVP with Mmvs candidate list or merging candidate index of the affine with mmvd candidate list where x0, y0 specify the location (x0, y0) of the top-left luma sample of the considered coding block relative to the top-left luma sample of the picture. If none of sbTMVP with Mmvs candidates is valid, affineMmvdMergeIdx is equal to sbtmvp_merge_idx and sbtmvpMmvdMergeIdx is equal to 0; otherwise, affineMmvdMergeIdx is equal to affine_merge_idx and sbtmvpMmvdMergeIdx is equal to stmvp_merge_idx.

### Syntax Design 4:

In one embodiment, the motion vector shift for a sbTMVP can be signalled through the scheme similar to the MMVD scheme. In particular, after a merge candidate is selected by a merge index, it is further refined by the signalled MVDs information. The further information includes, but not limited to, an index to specify motion magnitude and an index to indicate the motion direction. It is noted that the set of the motion magnitudes and the set of the motion directions can contain any predefined values and is not limited to the set used in the current MMVD design in VVC as illustrated in the Table 4 and Table 5, respectively.

TABLE 4
Specification of MmvdDistance[ x0 ][ y0 ]
based on mmvd_distance_idx[ x0 ][ y0 ]

| | MmvdDistance[ x0 ][ y0 ] | |
|---|---|---|
| mmvd_distance_idx | ph_fpel_mmvd_en- | ph_fpel_mmvd_en- |
| [ x0 ][ y0 ] | abled_flag == 0 | abled_flag == 1 |
| 0 | 1 | 4 |
| 1 | 2 | 8 |
| 2 | 4 | 16 |
| 3 | 8 | 32 |
| 4 | 16 | 64 |
| 5 | 32 | 128 |
| 6 | 64 | 256 |
| 7 | 128 | 512 |

TABLE 5
Specification of MmvdSign[ x0 ][ y0 ] based on
mmvd_direction_idx[ x0 ][ y0 ]

| mmvd_direc- | | |
|---|---|---|
| tion_idx[ x0 ][ y0 ] | MmvdSign[ x0 ][ y0 ][0] | MmvdSign[ x0 ][ y0 ][1] |
| 0 | +1 | 0 |
| 1 | −1 | 0 |
| 2 | 0 | +1 |
| 3 | 0 | −1 |

Based on the proposed scheme, in yet another embodiment, the merge candidate list can be derived by a merge list construction process which is the same as the process of regular merge candidate list construction. Since the merge candidate can be a bi-directional merge candidate, additional syntax elements are signalled to indicate which direction is used as the motion vector shift.

Based on the disclosed scheme, in yet another embodiment, the merge candidate list can be derived by only inserting uni-directional motion vector into the candidate list. Since the merge candidate can only be an uni-directional merge candidate, the signalled MVDs information is directly added to the selected uni-directional merge candidate to derive the motion vector shift for the sbTMVP.

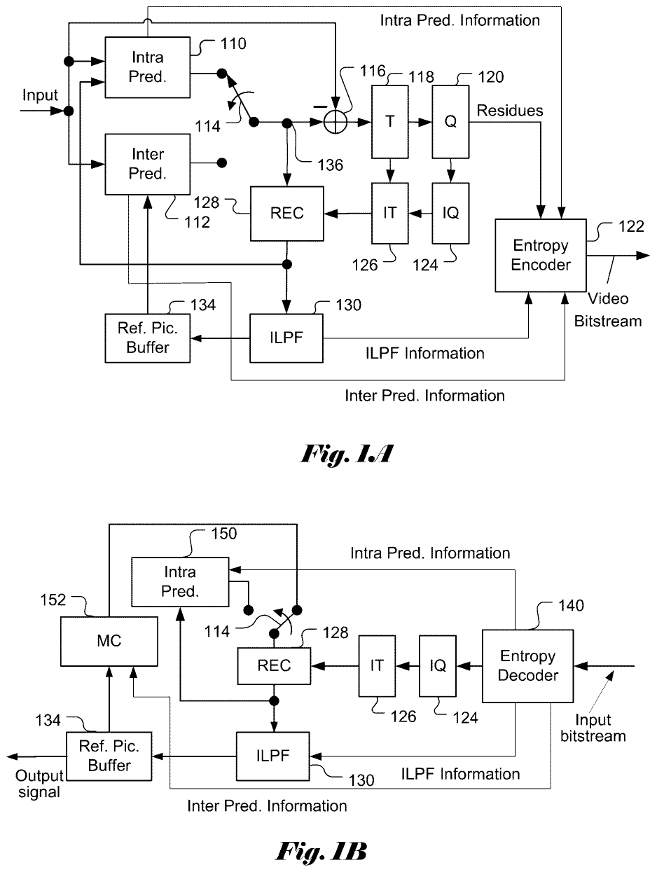

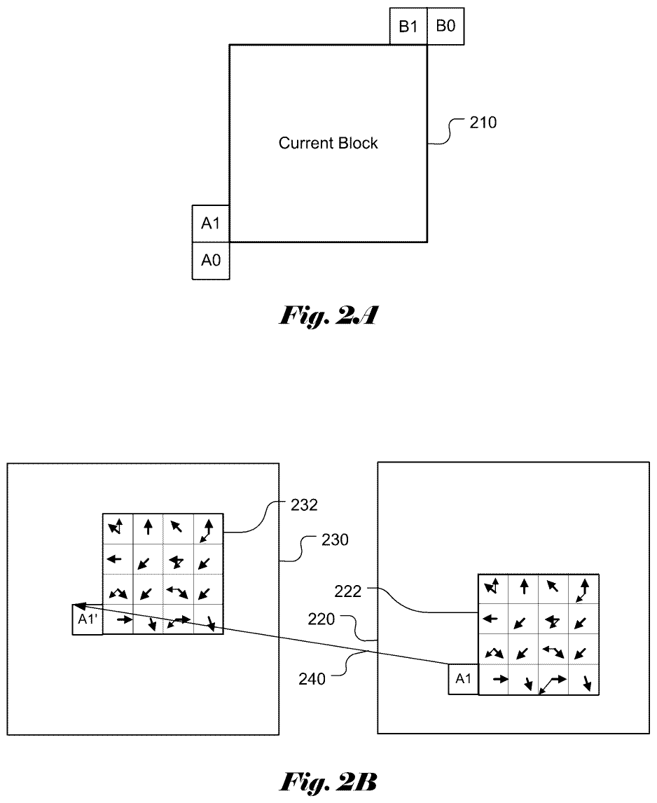

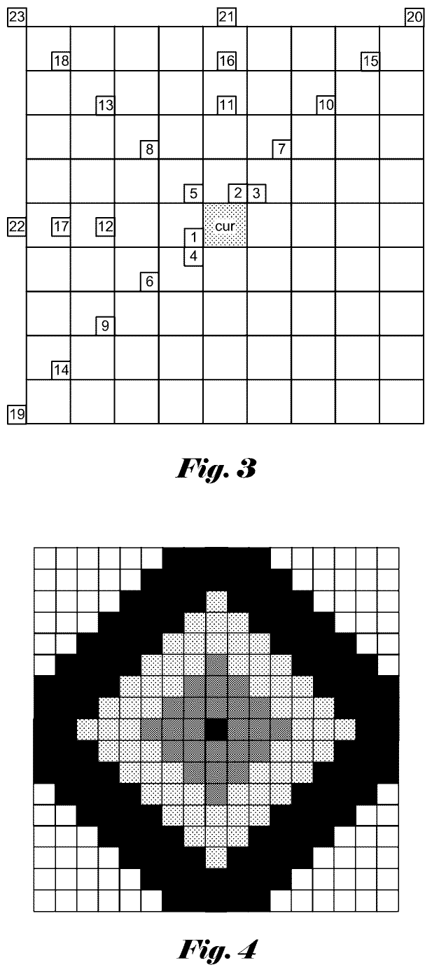

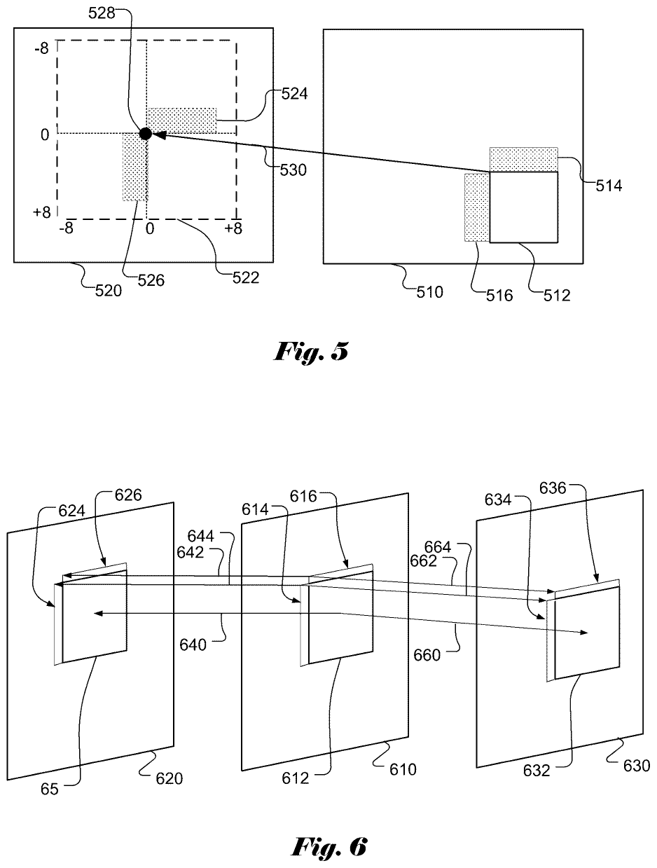

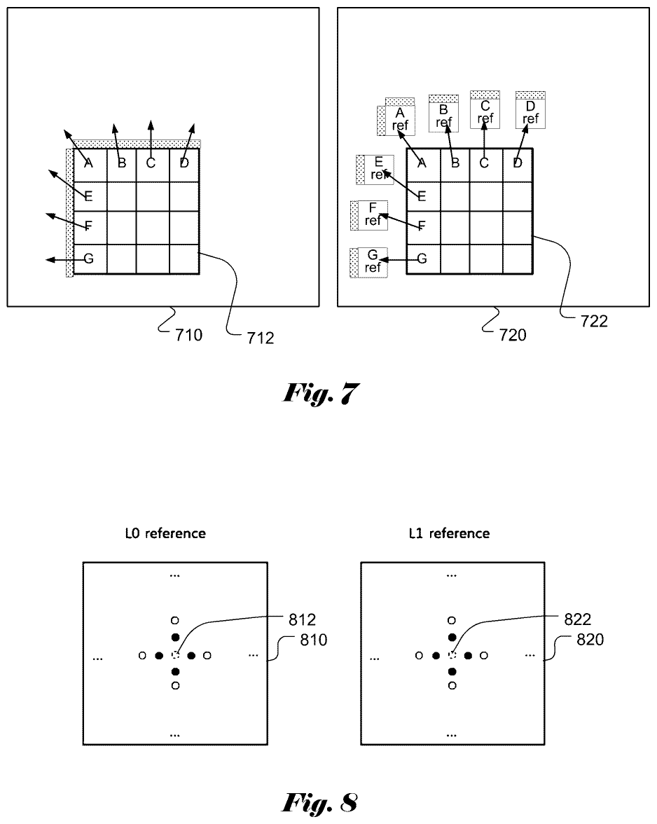

Any of the SbTMVP methods with multiple motion shifts das described above can be implemented in encoders and/or decoders. For example, any of the proposed SbTMVP multiple motion shifts methods can be implemented in an inter coding module and/or a merge/AMVP candidate derivation module of an encoder (e.g. Inter Pred. 112 in FIG. 1A), or a motion compensation module (e.g., MC 152 in FIG. 1B) and/or a merge/AMVP candidate derivation module of a decoder. Alternatively, any of the proposed methods can be implemented as a circuit coupled to the inter coding module and/or a merge/AMVP candidate derivation module of an encoder and/or motion compensation module and/or a merge/AMVP candidate derivation module of the decoder. While the Inter-Pred. 112 and MC 152 are shown as individual processing units to support the SbTMVP methods, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

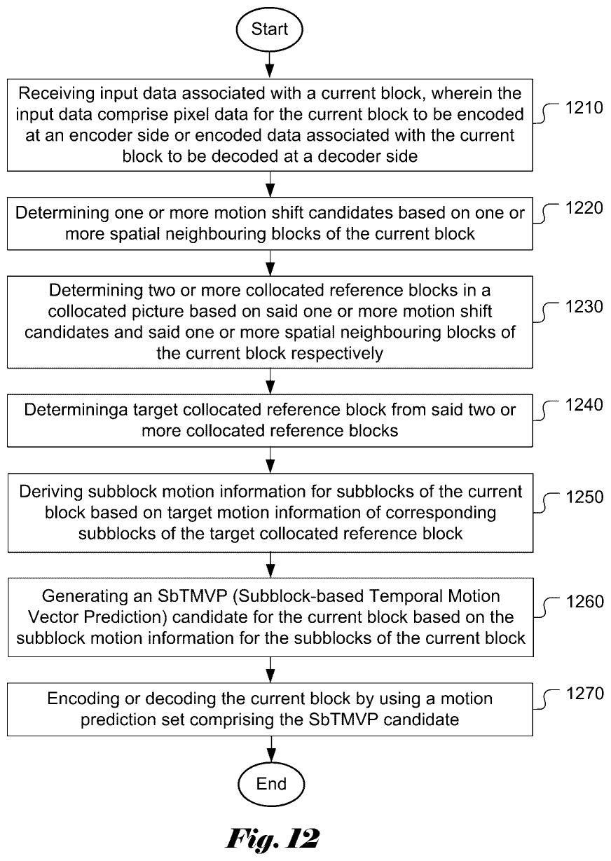

FIG. 12 illustrates a flowchart of an exemplary video coding system that utilizes SbTMVP with multiple motion shifts according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current block are received in step 1210, wherein the input data comprise pixel data for the current block to be encoded at an encoder side or encoded data associated with the current block to be decoded at a decoder side. One or more motion shift candidates are determined based on one or more spatial neighbouring blocks of the current block in step 1220. Two or more collocated reference blocks in a collocated picture are determined based on said one or more motion shift candidates and said one or more spatial neighbouring blocks of the current block respectively in step 1230. A target collocated reference block is determined from said two or more collocated reference blocks in step 1240. Subblock motion information for subblocks of the current block is derived based on target motion information of corresponding subblocks of the target collocated reference block in step 1250. An SbTMVP (Subblock-based Temporal Motion Vector Prediction) candidate for the current block is generated based on the subblock motion information for the subblocks of the current block in step 1260. The current block is encoded or decoded by using a motion prediction set comprising the SbTMVP candidate in step 1270.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprise pixel data for the current block to be encoded at an encoder side or encoded data associated with the current block to be decoded at a decoder side;
determining one or more motion shift candidates based on one or more spatial neighbouring blocks of the current block;
determining two or more collocated reference blocks in a collocated picture based on said one or more motion shift candidates and said one or more spatial neighbouring blocks of the current block respectively;
determining a target collocated reference block from said two or more collocated reference blocks;
deriving subblock motion information for subblocks of the current block based on target motion information of corresponding subblocks of the target collocated reference block;
generating an SbTMVP (Subblock-based Temporal Motion Vector Prediction) candidate for the current block based on the subblock motion information for the subblocks of the current block; and
encoding or decoding the current block by using a motion prediction set comprising the SbTMVP candidate.

2. The method of claim 1, wherein said two or more collocated reference blocks in the collocated picture are determined by locating a base collocated reference block according to a location of a target spatial neighbouring block of the current block and a target motion shift candidate associated with the target spatial neighbouring block of the current block, and one or more additional collocated reference blocks are located by adding one or more additional motion shifts to the base collocated reference block.

3. The method of claim 2, wherein the target spatial neighbouring block of the current block corresponds to a bottom-left neighbouring block and three additional collocated reference blocks are located on top side, left side and bottom side of the base collocated reference block respectively.

4. The method of claim 2, wherein the target collocated reference block is determined from said two or more collocated reference blocks according to Rate-Distortion costs associated with said two or more collocated reference blocks.

5. The method of claim 1, wherein a first syntax is signalled or parsed to indicate whether said two or more collocated reference blocks are used.

6. The method of claim 5, wherein when the first syntax indicates said two or more collocated reference blocks being used, a second syntax is signalled or parsed to indicate the target collocated reference block as selected.

7. The method of claim 1, wherein when two or more motion shift candidates based on two or more spatial neighbouring blocks of the current block are determined, said two or more collocated reference blocks in the collocated picture comprise one base collocated reference block from each of said two or more motion shift candidates and said one base collocated reference block is located according to a location of each spatial neighbouring block of the current block and a target motion shift candidate associated with said one base collocated reference block.

8. The method of claim 7, wherein a first syntax is signalled or parsed to indicate whether said two or more motion shift candidates are used.

9. The method of claim 8, wherein when the first syntax indicates said two or more motion shift candidates being used, a second syntax is signalled or parsed to indicate which base collocated reference block is selected.

10. The method of claim 8, wherein the first syntax is signalled or parsed only if affine MMVD is disabled for the current block.

11. The method of claim 1, wherein corresponding SbTMVP candidates associated with said two or more collocated reference blocks are reordered according to ARMC-TM (Adaptive Reordering of Merge Candidates with Template Matching).

12. The method of claim 11, wherein after the corresponding SbTMVP candidates are reordered, N best candidates are used for further rate-distortion cost evaluation, and wherein N is smaller than or equal to a total number of the corresponding SbTMVP candidates.

13. The method of claim 12, wherein a set of indexes is used to indicate the N best candidates and a smaller index value is signalled using a shortened codeword.

14. The method of claim 11, wherein one or more templates of the current block and one or more corresponding templates of the target collocated reference block are used for the ARMC-TM.

15. The method of claim 11, wherein one or more templates of the current block and one or more corresponding templates of subblocks associated with the target collocated reference block are used for the ARMC-TM, and wherein the subblocks of the target collocated reference block are located based on subblock motions.

16. An apparatus for video coding, the apparatus comprising one or more electronic circuits or processors arranged to:
receive input data associated with a current block, wherein the input data comprise pixel data for the current block to be encoded at an encoder side or encoded data associated with the current block to be decoded at a decoder side;
determine one or more motion shift candidates based on one or more spatial neighbouring blocks of the current block;
determine two or more collocated reference blocks in a collocated picture based on said one or more motion shift candidates and said one or more spatial neighbouring blocks of the current block respectively;
determine a target collocated reference block from said two or more collocated reference blocks;
derive subblock motion information for subblocks of the current block based on target motion information of corresponding subblocks of the target collocated reference block;
generate an SbTMVP (Subblock-based Temporal Motion Vector Prediction) candidate for the current block based on the subblock motion information for the subblocks of the current block; and
encode or decode the current block by using a motion prediction set comprising the SbTMVP candidate.
